(19) United States
(12) Patent Application Publication
(10) Pub. No.: US 2007/0203587 A1
(43) Pub. Date: Aug. 30, 2007

(54) System for preparing a beverage

(75) Inventors: Jan Hakan Erlandsson, Whaddon (GB); David Stuart Harris, Milton (GB); Hans Kodden, Hoogeveen (NL); John Robert McGarva, St. Neots (GB); Max William Middleton, Cambridge (GB); Christopher James Smith, Swaffham Prior (GB); Thomas Christopher St. Quintin, Cambridge (GB); Jonathan David Tuckwell, Cambridge (GB); Eric Wilkinson, Hilton (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/584,104

(22) PCT Filed: Dec. 16, 2004
(86) PCT No.: PCT/IB04/52828

§ 371 Date: Jun. 22, 2006

(30) Foreign Application Priority Data
Dec. 23, 2003 (EP) 03258180.3

(51) Int. Cl. G05B 11/01

(52) U.S. Cl. 700/11

(57) ABSTRACT

The invention relates to a system (1) for preparing a beverage from a beverage base material (5), comprising an apparatus (2) for preparing a beverage extract from a beverage base material (5) and a liquid and a container (3) for containing the beverage base material (5) during storage, the container (3) comprising an identifier (4) provided with data (A), which apparatus (2) comprises a reader (14) for reading the data (A) in said identifier (4) and a controller (6) for controlling a beverage brewing process in dependence on the data (A) during operation of the apparatus (2). In this manner the brewing process parameters for the beverage extract can be optimized for the specific variety of beverage in a user-friendly manner.

The invention relates to a system for preparing a consumable matter, comprising an apparatus for preparing the consumable matter, and a container for containing a basis material for the consumable matter during storage.

The invention further relates to an apparatus for preparing a consumable matter, a container for containing a basis material for the consumable matter during storage, and an identifier, for use with the system according to the invention.

A system for preparing a consumable matter as described in the opening paragraph is known from EP0904718. The known system comprises an apparatus for preparing a coffee extract from ground coffee and water. The ground coffee is contained in a pouch made of a filter material, which pouch is placed in a holder in the apparatus. During operation hot water passes through the pouch to create a coffee extract which is then transported into a cup. The coffee pouches are sold in a container, in this case a bag, which contains a number of pouches. Numerous varieties of coffee pouches are offered to the consumer, who can select his or her preferred cup of coffee. These varieties may comprise for example coffee with special flavors (vanilla, chocolate etc.), coffee of varying strengths, or coffee without caffeine.

It is a drawback of the current system that it is not possible to obtain an optimal beverage result for all varieties of beverage with the system. Especially since new varieties of pouches are being developed which may contain, for example, ground coffee with milk powder, or even other types of beverage base material such as chocolate powder, this becomes an issue. The brewing process to obtain optimal beverage results for a strong coffee variety is different from the brewing process of, for example, hot chocolate, or a cappuccino variety. The parameters of the brewing process in the known system, such as water temperature and flow rate, are fixed and will thus be used for all different varieties of beverages. When different varieties of beverage are to be prepared with this system and these parameters, this will result in a number of extracted beverages which do not have the taste they might be expected to have, had they been brewed using the right parameters.

It is an object of the invention to provide a system for preparing a consumable matter in which the parameters can be tailored to their optimum for the specific variety of consumable matter, in a user-friendly manner.

To achieve this object, a system according to the invention is characterized in that the container comprises an identifier provided with data, and the apparatus comprises a reader for reading the data in said identifier, and a controller for controlling a preparation process during operation of the apparatus based on the data. When a user wants to prepare a consumable matter, such as a cup of beverage, for example coffee, the container is picked up and placed in the vicinity of the apparatus, to take out the basis material, in this case coffee pad. This basis material is then placed in the apparatus for preparing a consumable matter, for example an apparatus for preparing a beverage. When the container is present at a certain predetermined distance from the apparatus, the reader in the apparatus is able to read the data that are provided in the identifier comprised in the container. Based on this information, the controller in the apparatus controls a preparation during operation of the apparatus, which is based on the data in the identifier. In this manner the parameters of the preparation process can be tailored to their optimum, to obtain an optimum result for the prepared consumable matter.

An embodiment according to the invention is characterized in that the container comprises an identifier provided with data, and the apparatus comprises a reader for reading the data in said identifier and a controller for controlling a beverage brewing process in dependence on the data during operation of the apparatus. When a user wants to prepare a cup of beverage, for example coffee, the container is picked up and placed in the vicinity of the apparatus, and the beverage base material is taken out. This beverage base material is then placed in the apparatus for preparing a beverage. When the container is present at a certain predetermined distance from the apparatus, the reader in the apparatus is able to read the data provided in the identifier comprised in the container. Based on this information, the controller in the apparatus controls a beverage brewing process during operation of the apparatus, which is based on the data in the identifier. In this manner the parameters of the brewing process can be optimized so as to obtain an optimum beverage result.

An embodiment of a system according to the invention is characterized in that the data comprise information identifying the type of beverage base material comprised in the container. In this manner the brewing process parameters can be optimized for the specific type of beverage such as, for example, coffee or hot chocolate.

An embodiment of a system according to the invention is characterized in that the data comprise information identifying a storage life of the beverage base material. Next to identification of the type of beverage, the identifier comprised in the container may serve to identify the storage life, and thus the freshness, of the beverage base material in the container.

If, for example, a container is identified to have a packaging date before a pre-determined date in the past, a warning may be given to the user that the taste of the resulting beverage may be less than optimum because of the age of the beverage base material. Another possibility is that the parameters of the brewing process are adjusted to provide a beverage extract which is of good quality, even when the beverage base material is less fresh.

It is advantageous when the identifier comprises an identifier chosen from a group of radio frequency transponders and bar codes, and the reader comprises a reader chosen from a group of radio frequency readers and bar code readers.

An embodiment of a system according to the invention is characterized in that said controller comprises a processing unit which comprises a plurality of pre-programmed brewing process parameters, from which a selection is made during operation in dependence on the data as read. Various brewing processing parameters for different beverage types are pre-programmed into the processing unit and are assigned different integers. The integer corresponding to the most appropriate program for the beverage base material in the container is present as the data in the identifier and is read as such by the reader when the container is present at a certain predetermined distance from the apparatus. Based on this read integer, the program with appropriate brewing processing parameters is then activated in the apparatus by the controller for preparing a beverage extract.

An embodiment of a system according to the invention is characterized in that the identifier comprises an element which is detachably connected to the container. In this manner the user is offered the option to bring only the identifier itself in the vicinity of the apparatus, while the container may remain at another location. Furthermore, this offers the possibility of storing the identifier with the reader in the apparatus, which is advantageous if a user has the habit of preparing only one type of beverage.

It is advantageous when said element comprises one of a group of tags comprising tags with dielectric values, tags with punched holes, and tags with resistance values, and the reader comprises one of a group of readers comprising capacitor arrangements for receiving dielectric tags, optical and mechanical readers, and resistance measuring arrangements.

The invention further relates to a container for containing a beverage base material during storage, for use with the system according to the invention, characterized in that said container comprises an identifier provided with data, said data being readable by a reader in an apparatus for preparing a beverage, and a beverage brewing process being controlled in dependence on the data during operation of the apparatus.

The invention further relates to an apparatus for preparing a beverage extract from beverage base material and a liquid, for use with the system according to the invention, characterized in that said apparatus comprises a reader for reading data in an identifier which is comprised in a container for containing a beverage base material, and a controller for controlling a beverage brewing process in dependence on the data during operation of the apparatus.

The invention further relates to an identifier for use with the system according to the invention, characterized in that said identifier comprises a separate element for inclusion in a container for containing the beverage base material during storage, which element is provided with data which are readable by a reader in an apparatus for preparing a beverage, and a beverage brewing process being controlled in dependence on said data during operation of the apparatus.

The invention will be described in more detail below with reference to the drawings, in which:

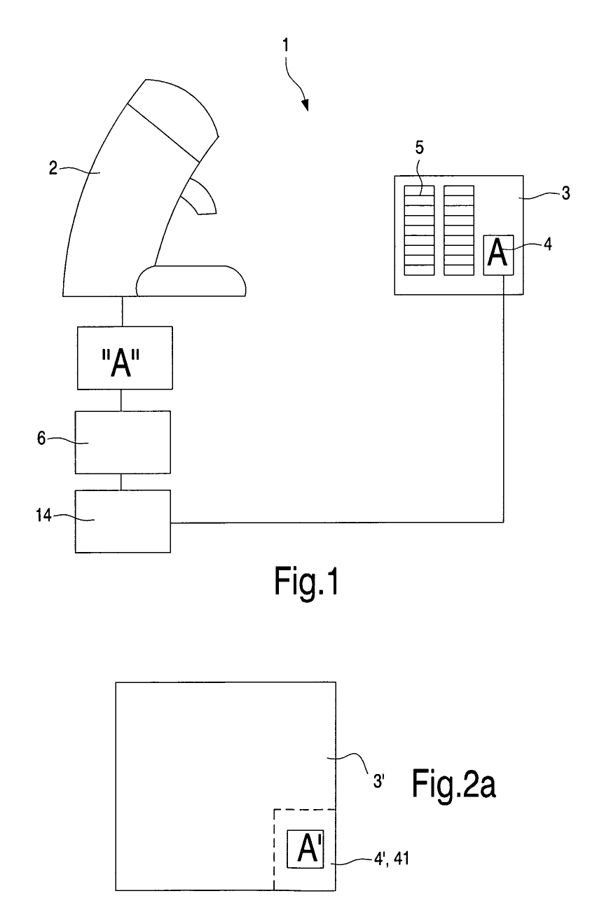

FIG. 1 is a schematic view of a system according to the invention, and

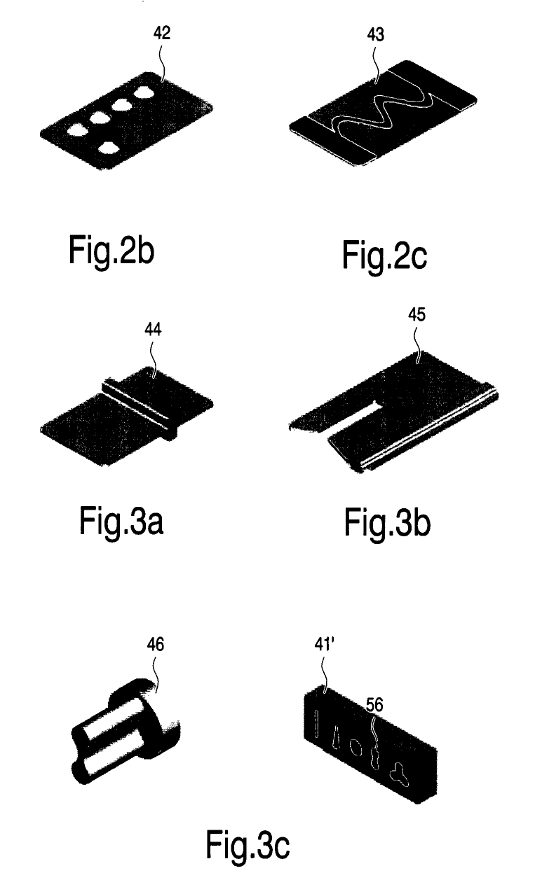

FIG. 2a is a schematic view of a container according to the invention,

FIGS. 2b and c show embodiments of an identifier according to the invention, and

FIGS. 3a, 3b and 3c are perspective views of further embodiments of an identifier according to the invention.

FIG. 1 is a schematic view of a system 1 according to the invention, comprising an apparatus 2 in this embodiment an apparatus for preparing a beverage extract from beverage base material 5 and a liquid, and a container 3 for containing the beverage base material 5 during storage. In this embodiment, the beverage base material 5 comprises a plurality of pouches 51 made of filter material and containing ground coffee. One or two pouches, depending on whether one or two cups of beverage are to be prepared, are placed in a holder in the apparatus, to prepare a coffee extract from the ground coffee and water that flows through the pouch during the brewing process in the apparatus. It is noted, however, that the beverage base material 5 may comprise alternative types of beverage base material, with or without an enclosure of filter material such as, for example, loose ground coffee, chocolate milk powder, or tea leaves in a teabag. The container 3 in this embodiment comprises a flexible bag comprising a plurality of coffee pouches, but it is noted that this container may comprise any known type of container such as, for example, tins, canisters, boxes, etc., for containing any type of beverage base material.

The container 3 comprises an identifier 4 provided with data A, and the apparatus 2 comprises a reader 14 for reading the data A in said identifier. The identifier in this embodiment comprises a radio frequency transponder which can be read by a radio frequency reader comprised in the apparatus. In this embodiment, a radio frequency transponder is placed in every bag, and a radio frequency reader incorporated into the beverage maker. There are several methods of identifying objects using RFID, but the most common one is to store a serial number that identifies a product, and perhaps other information, on a microchip that is attached to an antenna (the chip and the antenna together are called an RFID transponder or an RFID tag). The reader sends out electromagnetic waves that induce a current in the tag's antenna, powering the chip, and enabling transmission of the identification information back to the reader. The reader demodulates the radio waves returned from the RFID tag, then interprets the serial number. In this application, the range of the reader will be limited so that data stored on the tag can be read by bringing the bag into close proximity with the beverage maker, avoiding any conflict with other bags the user may have purchased.

Interpretation of the tag's data will lead to verification of the manufacturer and unique identification of the variety of beverage within the pad, so that the brewing parameters can be optimized for the drink. This optimization can be achieved either by selection of pre-programmed parameters, or by interpretation of the data provided by the RF tag into brewing instructions, increasing brewing versatility and allowing the introduction of new beverage types after manufacture of the beverage maker. If no tag or a tag of some unrecognized format is detected, default brewing parameters will be adopted.

It is noted that other known types of identifier technologies, such as bar codes on the container and a bar code reader in or connected to the apparatus, may also be applied. The apparatus 2 further comprises a controller 6 for controlling a beverage brewing process “A” during operation of the apparatus 2 based on the data A. This will be further illustrated with an example.

In this embodiment, the data A comprise information identifying the type of beverage base material present in the container, for example, ‘regular roast coffee’. A user will pick up the container and bring it into the vicinity of the apparatus for preparing a beverage, in this embodiment coffee extract. When the container is in a certain pre-determined area around the apparatus, said area being defined by the chosen identifier and reader, the reader 14 in the apparatus is able to read the type of beverage base material that is contained in the container, in this case ‘regular roast coffee’. After reading of this data, the controller 6 in the apparatus 2 is ready to initiate a beverage brewing process which is especially designed for this specific type of beverage. The specific beverage brewing process comprises the optimum parameters such as fluid temperature, fluid pressure, and fluid pass-through rate for this specific type of beverage, which ensure an optimal cup of ‘regular roast coffee’ resulting from the beverage brewing process in the apparatus 2. It is noted that the specific brewing process in the apparatus may start after activation of the on/off button of the apparatus by the user, after a certain pre-determined period of time starting from the moment the data are read, or upon detection of a pouch being placed in the holder of the apparatus.

In this embodiment, the controller 6 comprises a processing unit which comprises a plurality of pre-programmed brewing process parameters from which a selection is made during operation dependent on the data as read. The processing unit in the apparatus comprises various pre-programmed brewing processes, which are assigned different integers. The data in the identifier in each container comprise an integer corresponding to the most appropriate brewing process for the specific type of beverage base material comprised in the container. After reading out of the integer by the reader, the correct pre-programmed brewing process is selected by the controller in dependence on that integer, to control the operation of the apparatus. In another embodiment, the data in the identifier itself comprise specific brewing parameters such as a pre-selected fluid quantity, fluid temperature, and fluid pass-through rate, which are read out by the reader and transferred to the control unit 6 to control the beverage brewing process.

Furthermore, the apparatus may comprise a function to add additives such as milk, sugar, cream, and the like to the beverage extract, which addition can be controlled by reference to the data in the identifier.

The data A comprised in the identifier may also comprise information to identify a storage life of the beverage base material in addition to or instead of information on the type of beverage. In this manner the freshness of the beverage base material present in the container can be determined. The time period during which the beverage base material has been contained in the container has an important influence on the taste of the finally resulting beverage extract. Coffee extract resulting from a recently packaged coffee pouch has a different taste from coffee extract resulting from an ‘older’ coffee pouch which has been stored for some time in a container. In the system according to the invention, optimum brewing parameters can be chosen in dependence on the storage life information so as to obtain a good beverage extract result even if the beverage base material has been stored for some time.

Furthermore, this data may comprise in addition, or in itself, information identifying the company which supplies the container with the beverage base material. The apparatus is specifically designed to provide optimum beverage results from certain specially developed beverage base materials. In this manner a certain quality standard can be offered to the users and be maintained over a long period of time. If other companies sell comparable beverage base materials for use in the apparatus, there is a risk that this quality standard cannot be maintained because of a lower-quality beverage base material. This will also cause the apparatus to produce a beverage extract of a lower quality, which is undesirable. Hence, it is preferable that the best beverage extract results are obtainable by using an apparatus with a container according to the invention. The brewing parameters to obtain this optimum beverage extract results are controlled on the basis of the data read from the identifier comprised in the container. If no container with an identifier according to the invention is used, or if the identifier offered is not recognized by the apparatus, default brewing parameters will be adopted.

FIG. 2a is a schematic view of a container 3′ for containing a beverage base material during storage, for use with a system according to the invention. Said container 3′ comprises an identifier 4′ provided with data A′, said data A′ being readable by a reader in an apparatus for preparing a beverage, and a beverage brewing process during operation of the apparatus being controlled in dependence on the data. In this embodiment, the identifier 4′ comprises an element 41 which is detachably connected to the container 3′. The element 41 in this embodiment is connected to the container via a perforated line and can be torn off the container 3′. It is noted that the element 41 may also be detachably connected to the container by means of other known types of connections, the element for example comprising a sticker or a clip which is removably attached to the container.

In another embodiment, the identifier comprises a separate element for inclusion in a container for containing the beverage base material during storage, which element is provided with data which can be read by a reader in an apparatus for preparing a beverage, and a beverage brewing process during operation of the apparatus being controlled in dependence on said data.

Thus, the identifier may comprise an element which is detachably connected to the container, or a separate, loose element which is placed in the container together with the beverage base material during production. These detachable or loose elements may comprise, for example, a tag 42 with a number of punched holes, as shown in FIG. 2b. The pattern of holes on this tag 42 can be read optically or mechanically, so as to select a pre-determined beverage brewing program or to determine the processing parameters. Furthermore, these elements may comprise, for example, a tag 43 with a printed conduction track or a resistive wire insert, as shown in FIG. 2c. This tag 43 can be inserted into a recess in the body of the beverage making apparatus, where pins connect to each end of the resistive track. The resistance of this system is measured, and the range into which it falls is used to define the beverage processing program.

Other embodiments of these elements are shown in FIGS. 3a and 3b. FIG. 3a shows a rigid tag 44 with a flange positioned at a variable distance from its free end, which tag is included in the container with the beverage base material. This tag 44 can be inserted into a recess in the body of the beverage making apparatus, where it operates a spring-loaded sliding switch that indicates the length of the tag and thus controls the beverage processing parameters. FIG. 3b shows a rigid tag 45 with a notch positioned a variable distance from an orientation feature at one side of the tag, which is included in the container with the beverage base material. This tag can be inserted into a recess in the beverage making apparatus, where it operates a sliding switch that indicates the position of the notch and thus controls the beverage brewing parameters.

FIG. 3c shows a further embodiment of an identifier according to the invention. A limited selection of cross sections, none of which can pass through any of the others, is defined, and each section is assigned to a different beverage brewing program. A rigid key element 46 with a pre-determined cross section from this selection, chosen in dependence on the type of beverage to be made, is included in the container with the beverage base material. This key element 46 interfaces with a unique mating hole 56 in the beverage making apparatus, operating a switch that selects the desired beverage brewing program.

It is noted that, in addition to systems for preparing coffee extract from ground coffee and water, the invention is also advantageously applicable to other systems for preparing a beverage extract from beverage base material and a liquid. The beverage base material may comprise, for example, other types of beverage base material such as milk powder, chocolate milk powder, soft drink syrup, tea leaves, dried soup, etc. These materials may be in loose form, or may be enclosed in a filter material or a capsule. The liquid may comprise, for example, other types of liquid such as milk, beer, carbonated water, etc. It is noted that the term beverage brewing process is not limited to the preparation of hot beverage extracts such as coffee, but that the preparation of cold drinks such as soft drinks is also included. The specific brewing parameters that are controlled via the identifier are dependent on the type of beverage extract to be prepared.

With a system, an apparatus, a container, and an identifier according to the invention, the brewing process parameters for the beverage extract can be optimized for the specific variety of beverage in a user-friendly manner. The user does not have to press numerous buttons nor have to remember the correct settings of all relevant parameters for the brewing process in dependence on the type of beverage in order to obtain a beverage extract according to his or her preferences with an optimum taste. The system assures an optimization of the beverage brewing process for each specific type of beverage in a way which is easy and comfortable for users.

This optimization can be achieved either by selection of pre-programmed parameters with assigned different integers, which integers are included in the identifier, or by conversion of the data provided by the identifier into brewing instructions. In this manner the brewing versatility is increased. Furthermore, this allows the introduction of new beverage types after the manufacture of the beverage making apparatus, because the pre-programmed beverage brewing processes in the apparatus may be updateable via a connection to a public switching network such as the Internet. Alternatively, this update may take place in that the identifier transfers new beverage brewing programs to the controller in the apparatus.

It is noted that not only the control of the brewing process parameters, but also other functions of the apparatus may be activated by reading of the data comprised in the identifier. The addition of additives to the beverage extract was described above. If, for example, a display is provided on the apparatus, this display may show the type of beverage extract being prepared on the basis of the data in the identifier. Furthermore, the display may show, for example, the status of the brewing process during operation of the apparatus.

It is noted that until now a specific embodiment of a system for preparing a beverage from a beverage base material, comprising an apparatus for preparing a beverage extract from beverage base material and a liquid, and a container for containing the beverage base material during storage has been described.

It is noted however that next to an application with beverage base material and liquid, the invention also relates to other types of applications with consumable matter. In stead of a beverage base material in the container, and a liquid being delivered to that material by the apparatus and preparing a consumable matter, being a cup of beverage, using certain optimal brewing parameters defined by the identifier, in another embodiment the basis material in the container may already comprise a liquid, namely beer.

In this embodiment, a system according to the invention is characterized in that the container, in this embodiment a beer keg, comprises an identifier provided with data, and the apparatus, in this case a beer tapping device, comprises a reader for reading the data in said identifier, and a controller for controlling the preparation during operation of the apparatus based on the data. The identifier comprises for example information as to what kind of temperature the apparatus should cool the beer, before the beer is tapped into a glass, and the correct pressure to be applied in the apparatus. In this manner the parameters to be used in the tapping device for the tapping process can be tailored to their optimum, to obtain an optimum result of the tapped beer. Different types of beer may for example require, among other things, different tapping temperatures and pressures.

It is noted furthermore that next to an application with beverage base material and liquid, the invention also relates to other types of applications with consumable matter, such as for example a system for baking bread. In this embodiment, a system according to the invention is characterized in that the container, in this embodiment a container holding bread flour mix, comprises an identifier provided with data, and the apparatus, in this case a bread baking device, comprises a reader for reading the data in said identifier, and a controller for controlling the preparation of a baked bread during operation of the apparatus based on the data. The parameters controlled here may comprise for example baking temperature, duration of baking, rising time of dough, duration of kneading, etc., depending on the type of bread flour mix present in the container.

1. A system for preparing a consumable matter, comprising:
an apparatus for preparing the consumable matter, and
a container for containing a basis material for the consumable matter during storage,
characterized in that the container comprises an identifier provided with data and the apparatus comprises a reader for reading the data in said identifier and a controller for controlling a preparation process during operation of the apparatus based on the data.

2. A system according to claim 1, wherein the system is a system for preparing a beverage from a beverage base material comprising:
an apparatus for preparing a beverage extract from a beverage base material and a liquid, and
a container for containing the beverage base material during storage, and wherein the container comprises an identifier provided with data and the apparatus comprises a reader for reading the data in said identifier and a controller for controlling a beverage brewing process in dependence on the data during operation of the apparatus.

3. A system as claimed in claim 2, characterized in that the data comprise information identifying the type of beverage base material present in the container.

4. A system as claimed in claim 2, characterized in that the data comprise information identifying a storage life of the beverage base material.

5. A system as claimed in claim 1, characterized in that the identifier comprises an identifier chosen from a group of radio frequency transponders and bar codes, and the reader comprises a reader chosen from a group of radio frequency readers and bar code readers.

6. A system as claimed in claim 2, characterized in that said controller comprises a processing unit which comprises a plurality of pre-programmed brewing process parameters, from which a selection is made during operation in dependence on the data as read.

7. A system as claimed in claim 1, characterized in that the identifier comprises an element which is detachably connected to the container.

8. A system as claimed in claim 7, characterized in that said element comprises one from among a group of tags comprising tags with dielectric values, tags with punched holes, and tags with resistance values, and the reader comprises one of a group of readers comprising capacitor arrangements for receiving dielectric tags, optical and mechanical readers, and resistance measuring arrangements.

9. A container for containing a beverage base material during storage, for use with the system according to claim 1, characterized in that said container comprises an identifier provided with data, said data being readable by a reader in an apparatus for preparing a beverage, the beverage brewing process being controlled in dependence on the data during operation of the apparatus.

10. An apparatus for preparing a beverage extract from beverage base material and a liquid, for use with the system according to claim 1, characterized in that said apparatus comprises a reader for reading data in an identifier which is present in a container for containing a beverage base material and a controller for controlling the beverage brewing process in dependence on the data during operation of the apparatus.

11. An identifier for use with the system according to claim 1, characterized in that said identifier comprises a separate element for inclusion in a container for containing a basis material for the consumable matter during storage, which is provided with data which are readable by a reader in an apparatus for preparing a consumable matter, and a preparation process during operation of the apparatus being controlled based on said data.

12. An identifier for use with the system according to claim 1, characterized in that said identifier comprises a separate element for inclusion in a container for containing a beverage base material during storage, which is provided with data which are readable by a reader in an apparatus for preparing a beverage, the beverage brewing process being controlled in dependence on said data during operation of the apparatus.
